(19) United States
(12) Patent Application Publication
(10) Pub. No.: US 2017/0124638 A1
(43) Pub. Date: May 4, 2017

(54) ELECTRONIC DISPLAY BASED VIRTUAL STORE SYSTEM

(71) Applicant: MOBILIBUY LTD., Caesarea (IL)

(72) Inventors: Moti LEVY, Haifa (IL); Koby DANON, Tel Mond (IL); Ziv KITLARO, Pardes Hana-Karkur (IL)

(21) Appl. No.: 15/335,481

(22) Filed: Oct. 27, 2016

Related U.S. Application Data
(60) Provisional application No. 62/247,830, filed on Oct. 29, 2015.

(51) Int. Cl. G06Q 30/06; G06F 3/147; G06F 3/0482

(52) U.S. Cl. CPC G06Q 30/0643; G06F 3/0482; G06F 3/147

(57) ABSTRACT

An electronic display based virtual store system, constituted of: a plurality of electronic displays, each exhibiting a unique profile; and a server in communication with each of the plurality of electronic displays, wherein each of the plurality of electronic displays is arranged to display thereon one of a plurality of purchasable items;

wherein the server is arranged, responsive to information uniquely associated with a first of the plurality of electronic displays, to update the display of a second of the plurality of electronic displays whose unique profile exhibits a predetermined relationship with the unique profile of the first electronic display.

### CROSS REFERENCE TO RELATED APPLICATIONS

The present application claims priority from U.S. provisional application Ser. No. 62/247,830, filed Oct. 29, 2015 and entitled “ELECTRONIC DISPLAY BASED VIRTUAL STORE SYSTEM”, the entire contents of which are incorporated herein by reference.

### TECHNICAL FIELD

The invention relates generally to the field of virtual stores and in particular to an electronic display based virtual store system.

### BACKGROUND

Mobile commerce, also known as m-commerce, has increased exponentially in recent years due to the rapid increase in mobile phone usage and the technological advancements of mobile smart phones. The m-commerce market is estimated to be worth over 300 billion US dollars and is predicted to increase yearly, with double digit growth.

A key component which is still underdeveloped in m-commerce is the ability to exploit impulse purchasing. When potential consumers see an advertisement for an item on a poster, billboard, magazine, etc., they may purchase the item by searching for the item on the internet or by scanning a QR code associated with the item. Unfortunately, posters, billboards, etc., provide very limited options for offering items for impulse purchasing.

### SUMMARY OF THE INVENTION

Accordingly, it is a principal object of the present invention to overcome at least some of the disadvantages of prior art m-commerce platforms. This is provided in one embodiment by an electronic display based virtual store system, comprising: a plurality of electronic displays, each exhibiting a unique profile; and a server in communication with each of the plurality of electronic displays, wherein each of the plurality of electronic displays is arranged to display thereon one of a plurality of purchasable items; wherein the server is arranged, responsive to information uniquely associated with a first of the plurality of electronic displays, to update the display of a second of the plurality of electronic displays whose unique profile exhibits a predetermined relationship with the unique profile of the first electronic display.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding sections or elements throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice. In the accompanying drawings:

FIG. 1A illustrates a high level diagram of an electronic display based virtual store system, comprising a plurality of electronic displays, according to certain embodiments;

FIG. 1B illustrates a high level flow chart of a method of updating the display of the plurality of electronic displays of FIG. 1A, according to certain embodiments; and

FIG. 2 illustrates a high level flow chart of a virtual store real-time event related update method, according to certain embodiments.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

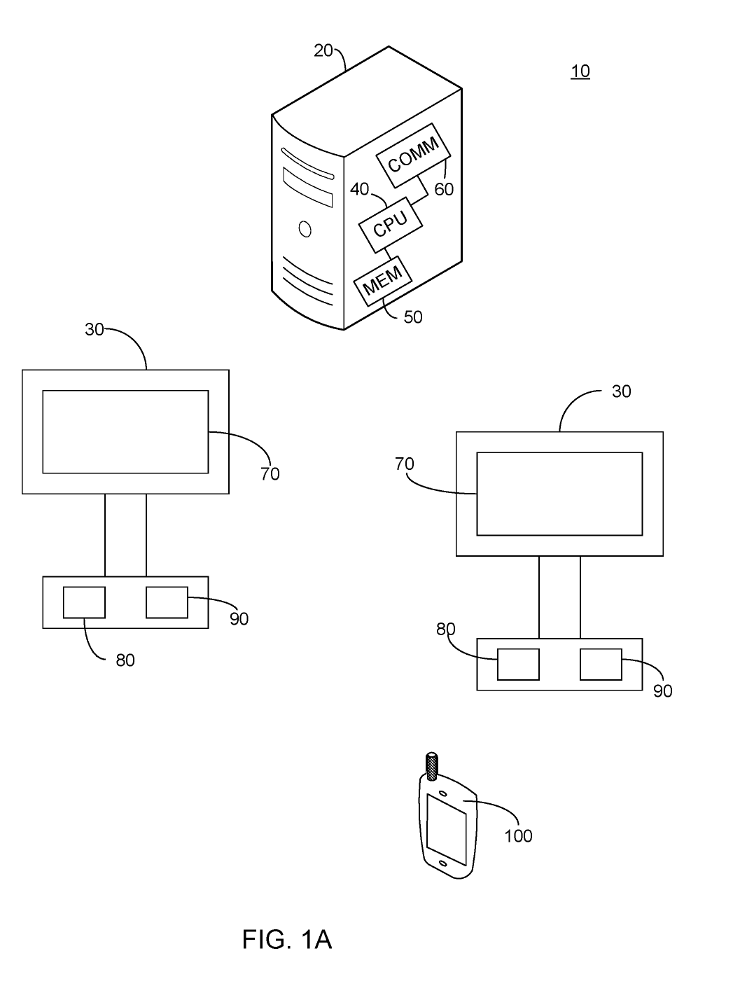

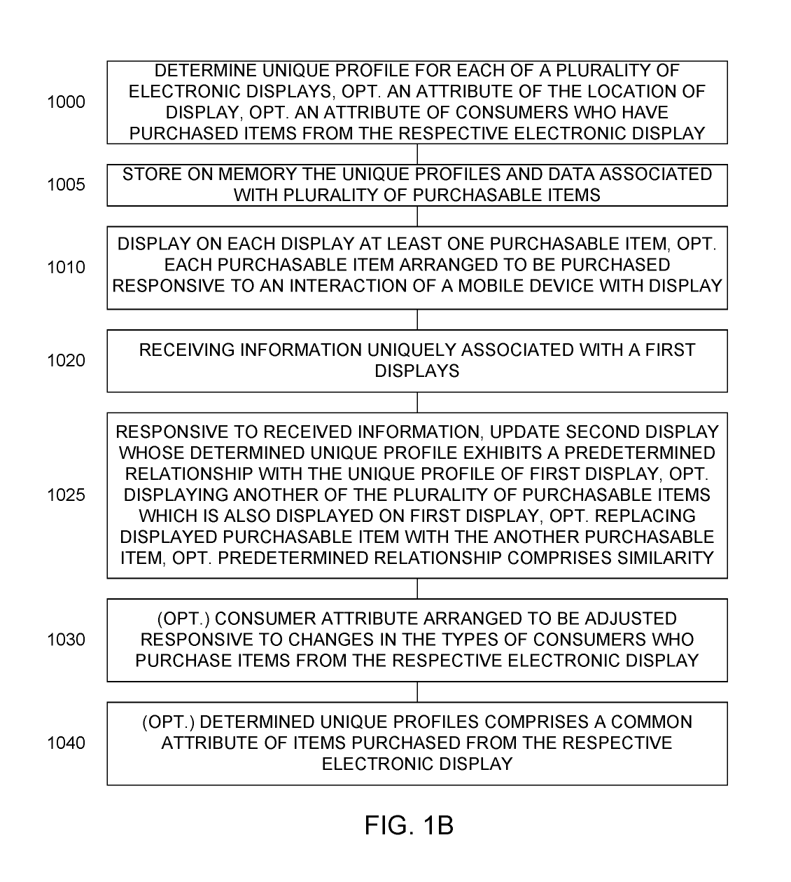

FIG. 1A illustrates a high level diagram of an electronic display based virtual store system 10 and FIG. 1B illustrates a high level flow chart of a method of operation of electronic display based virtual store system 10 for updating the display of electronic display devices 30 in accordance with unique information from other electronic display devices 30. Electronic display based virtual store system 10 comprises: a server 20; and a plurality of electronic display devices 30. Server 20 comprises: a processor 40; a memory 50; and a communication module 60. Each electronic display device 30 comprises: a display 70; a processor 80; and a communications module 90. In one embodiment, server 20 is implemented as a cloud server. In one embodiment, processor 40 is arranged to operate responsive to instructions stored on a local memory (not shown) of electronic display device 30. In one embodiment, display 70 is implemented as an LED, LCD or plasma screen. Communication module 90 of each electronic display device 30 is in communication with communication module 60 of server 20. In one embodiment, communication module 90 comprises a connection to the internet, particularly being one or more of a cellular antenna, a Wi-Fi antenna and a connection to an ADSL or cable modem. Each electronic display device 30 is located in a different geographical location.

In operation, in stage 1000 server 20 is arranged to determine a unique profile for each electronic display device 30. The unique profile of each electronic display device 30 comprises one or more attributes which are associated therewith. In one embodiment, including, but not limited to: attributes of the geographic location of the respective electronic display device 30; and attributes of consumers who have previously purchased items from the respective electronic display device 30, as will be described below.

In one non-limiting embodiment, the location attributes are any of: the continent; the country; the country region; the city; the population density of the city; the population size of a predetermined area within the vicinity of the respective electronic display device 30; the local climate; a localized area of the respective electronic display device 30, such as the neighborhood, the specific retail outlet, whether it is in an office building, a mall, a supermarket and a university, without limitation; and whether the respective electronic display device 30 is located indoors or outdoors.

In another non-limiting embodiment, the consumer attributes are any of: demographic attributes, such as age, gender, family size, household income, occupation, level of education, religion, race and nationality; psychographic attributes, such as personality, attitude and opinions towards particular issues, personal values, lifestyle, social class, activities and interests; and behavioral attributes, such as benefits previously sought, buyer readiness, loyalty to a particular brand/product, user status and personal occasions.

In stage 1005, server 20 is arranged to store on memory 50: the unique profiles of stage 1000; and data associated with each of a plurality of purchasable items, such as price, size and colors, without limitation.

In stage 1010, processor 80 of each electronic display device 30 is arranged to display on display 70 thereof at least one of the plurality of purchasable items whose associated data is stored on memory 50. Particularly, a graphical representation of the at least one purchasable item, and optionally information associated therewith, is displayed on display 70. Preferably, each purchasable item is arranged to be purchased responsive to an interaction of a mobile device 100 with the respective electronic display device 30 where the purchasable item is displayed thereon. In one embodiment, the purchasable item can be purchased responsive to any of: an image recognition of the displayed purchasable item by the mobile device 100 or by server 20; a scan of a QR code displayed on display 70; a communication with communication module 90; and any type of pattern recognition, including, without limitation voice, video, symbols or codes.

In stage 1020, server 20 is arranged to receive information uniquely associated with a first electronic display device 30. In stage 1025, server 20 is arranged, responsive to the received information of stage 1020, to update the display of a second electronic display device 30 whose unique profile exhibits a predetermined relationship with the unique profile of the first electronic display device 30, optionally the predetermined relationship being a similarity between the unique profile of the first electronic display device 30 and the unique profile of the second display device 30. Particularly, server 20 links together all electronic display devices 30 whose unique profiles exhibit a predetermined similarity therebetween. In one embodiment, the uniquely associated information comprises information regarding sales of a particular item. For example, a first electronic display device 30 and a second electronic display device 30 are located in separate engineering schools within the U.S., i.e. there is a similarity between the unique profiles of the first and second electronic display devices 30. Server 20 detects that a large number of copies of a particular textbook are being purchased at the first electronic display device 30 in the first engineering school. Server 20 is then arranged to send instructions to processor 80 of the second electronic display device 30, in the second engineering school, to display the particular textbook on display 70. Thus, server 20 has identified a popular item and presents it to an appropriate group of consumers, thereby increasing sales.

In one embodiment, the display update of the second electronic display device 30 comprises replacing a displayed purchasable item with another purchasable item which is also displayed on the first electronic display device 30. In the above example, the particular textbook is displayed on display 70 and a different textbook is removed from display 70. Although the above example relates to a pair of electronic display device 30, this is not meant to be limiting in any way. In another embodiment, display 70 of a plurality of electronic display devices 30, whose unique profiles exhibit the predetermined relationship with the unique profile of the first electronic display device 30, are updated with the purchasable item of the first electronic display device 30. In another embodiment, an update to display 70 of an electronic display device 30 with a particular purchasable item is performed only in the event that at least a predetermined amount of the particular purchasable item is being purchased at at least a predetermined number of electronic display devices 30 with unique profiles of the predetermined relationship, in accordance with predetermined business rules.

Although the example above is related to electronic display devices 30 with similar unique profiles, this is not meant to be limiting in any way. For example, if server 20 detects that sales are dropping at all outdoor electronic display devices 30 within a predetermined area, this can provide an indication that it has started to rain. As a result thereof, server 20 is in one embodiment arranged to display umbrellas at indoor electronic display device 30 within the predetermined area. Additionally, the predetermined relationship between unique profiles can be between any of the attributes of the respective profile, i.e. location attributes, consumer attributes or any other attributes, as described above.

The example given above is related to updating one electronic display device 30 responsive to sales detected at a second electronic display device 30, however this is not meant to be limiting in any way. In another embodiment, the electronic display device 30 is updated responsive to an event occurring at the other electronic display device 30, such as: a change in the weather; a shopping event; a transportation/traffic based event, such as a traffic accident or traffic jam; a political event, such as a rally; a social event; an entertainment event; a sports event; and a lifestyle event. In one further embodiment, electronic display device 30 is arranged to detect an event responsive to information from various web sites and/or external sensors, such as cameras, microphones, thermometers, barometers and humidity sensors. In another embodiment, instructions are received from a vendor to change the purchasable items displayed at a particular electronic display device 30 and server 20 is arranged to similarly update electronic display devices 30 exhibiting similar unique profiles.

In optional stage 1030, in the event that server 20 detects that the type of consumers who are purchasing items at a particular electronic display device 30 changes, one or more consumer attributes of the unique profile of the particular electronic display device 30 is adjusted in accordance with the consumer change.

In optional stage 1040, the unique profile of stage 1000 of each of two or more electronic display devices 30 comprises a common attribute of items which were purchased from the respected electronic display device 30. In one non-limiting embodiment, a common attribute of purchased items is any of the weight of the purchased items, the color of the purchased items and the material which the purchased items are made of. In the event that a predetermined relationship exists between a common item attribute of the unique profile of a first electronic display device 30 and a common item attribute of the unique profile of a second electronic display device 30, the unique profiles of the first and second electronic display devices 30 are considered to exhibit that predetermined relationship and the display of purchasable items at one electronic display device 30 is adjustable responsive to the other electronic display device 30, as described above in relation to stages 1020-1030.

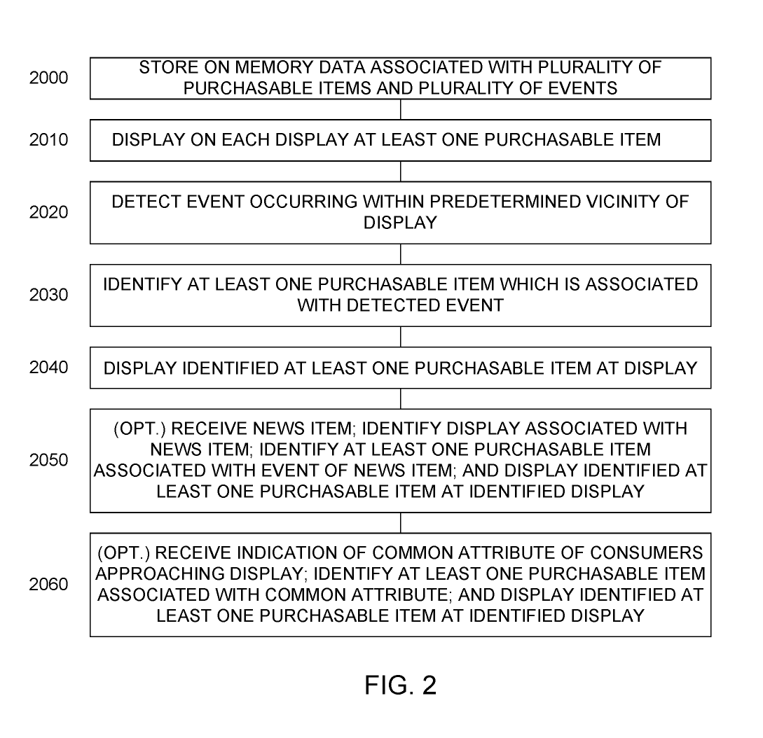

FIG. 2 illustrates a high level flow chart of a method of operation of electronic display based virtual store system 10 of FIG. 1A for updating the display of electronic display devices 30 in accordance with real-time events. In stage 2000, server 20 is arranged to store on memory 50: data associated with each of a plurality of purchasable items, as described above in relation to stage 1000; and data associated with each of a plurality of events. In stage 2010, processor 80 of each electronic display device 30 is arranged to display on display 70 thereof at least one of the plurality of purchasable items whose associated data is stored on memory 50, as described above in relation to stage 1010.

In stage 2020, server 20 is arranged to detect an event happening within a predetermined vicinity of a particular electronic display device 30. In one embodiment, the detected event is one of: a change in the weather; a shopping event; a transportation/traffic based event, such as a traffic accident or traffic jam; a political event, such as a rally; a social event; an entertainment event; a sports event; and a lifestyle event. In one embodiment, the event is a sudden event which has begun. In another embodiment, daily or weekly trends of events are detected, the event being the detected trend. In one embodiment, electronic display device 30 is arranged to detect an event responsive to information received from various web sites, web applications and/or external sensors, such as cameras, microphones, thermometers, barometers and humidity sensors.

In stage 2030, server 20 is arranged to identify at least one of the plurality of purchasable items which is associated with the detected event of stage 2020. In stage 2040, processor 80 of the particular electronic display device 30 is arranged, responsive to server 20, to display the identified at least one purchasable item of stage 2030 on display 70.

In optional stage 2050, server 20 is arranged to: receive a news item regarding an event; identify at least one of the electronic display devices 30 which is associated with event of the received news item; identify one of the plurality of purchasable items which is associated with the event of the received news item; and instruct the respective processor 80 to display the identified purchasable item on the identified electronic display device 30. In one non-limiting embodiment, the event within the news item is identified by extracting metadata from the news item, such as described in U.S. patent application publication U.S. 2013/0294746, published Nov. 7, 2013 to Oz et al., the entire contents of which are incorporated herein by reference.

In optional stage 2060, server 20 is arranged to: receive an indication of a common attribute of consumers who are approaching one of the plurality of electronic display devices 30; identify at least one of the plurality of purchasable items which is associated with the approaching consumers common attribute; and instruct processor 80 of the respective electronic display device 30 to display the identified purchasable item on display 70. For example, for an electronic display device 30 which is located within a train station, server 20 is arranged to determine the origin of an incoming train. In one embodiment, server 20 is arranged receive information regarding the origin of the incoming train from a server associated with the train station. Server 20 is then arranged to identify at least one purchasable item which is associated with the origin of the incoming train, the identified at least one purchasable item displayed on the electronic display device 30 at the train station. As a result, passengers of each train will be presented with different items based on their origin.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination. In particular, the invention has been described with an identification of each powered device by a class, however this is not meant to be limiting in any way. In an alternative embodiment, all powered device are treated equally, and thus the identification of class with its associated power requirements is not required.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. An electronic display based virtual store system, comprising:
a plurality of electronic displays, each exhibiting a unique profile; and
a server in communication with each of said plurality of electronic displays,
wherein each of said plurality of electronic displays is arranged to display thereon one of a plurality of purchasable items;
wherein said server is arranged, responsive to information uniquely associated with a first of said plurality of electronic displays, to update the display of a second of said plurality of electronic displays whose unique profile exhibits a predetermined relationship with said unique profile of said first electronic display.

2. The system of claim 1, wherein each of said plurality of purchasable items is arranged to be purchased responsive to an interaction of a mobile device with said respective electronic display where said purchasable item is displayed thereon.

3. The system of claim 1, wherein said display update of said second electronic display comprises a display of another of said plurality of purchasable items which is also displayed on said first electronic display.

4. The system of claim 3, wherein said display of the another purchasable item comprises a replacement of said displayed purchasable item with the another purchasable item.

5. The system of claim 1, wherein said predetermined relationship comprises a similarity between said unique profile of said first electronic display and said unique profile of said second electronic display.

6. The system of claim 1, wherein said unique profile of each of said plurality of electronic displays comprises an attribute of the location of said respective electronic display, said predetermined relationship comprising a predetermined relationship between said location attribute of said first electronic display and said location attribute of said second electronic display.

7. The system of claim 1, wherein said unique profile of each of said plurality of electronic displays comprises an attribute of consumers who have purchased items from said respective electronic display, said predetermined relationship comprising a predetermined relationship between said consumer attribute of said first electronic display and said consumer attribute of said second electronic display.

8. The system of claim 7, wherein said consumer attribute is arranged to be adjusted responsive to changes in the types of consumers who purchase items from said respective electronic display.

9. The system of claim 1, wherein said unique profile of each of said plurality of electronic displays comprises a common attribute of items purchased from said respective electronic display, said predetermined relationship comprising a predetermined relationship between said common item attribute of said first electronic display and said common item attribute of said second electronic display.

10. The system of claim 1, wherein said server is further arranged to:
receive an indication of a common attribute of consumers who are approaching one of said plurality of electronic displays;
identify one of said plurality of purchasable items which is associated with the approaching consumers common attribute; and
display said identified purchasable item on said electronic display.

11. The system of claim 1, wherein said server is further arranged to:
receive a news item;
identify one of said plurality of electronic displays which is associated with said received news item;
identify one of said plurality of purchasable items which is associated with said received news item; and
display said identified purchasable item on said identified electronic display.

12. An electronic display based virtual store system update method, the method comprising:
determining a unique profile for each of a plurality of electronic displays displaying on each of the plurality of electronic displays one of a plurality of purchasable items;
receiving information uniquely associated with a first of the plurality of electronic displays; and
responsive to said received information, updating the display of a second of the plurality of electronic displays whose determined unique profile exhibits a predetermined relationship with said unique profile of the first electronic display.

13. The method of claim 12, wherein each of the plurality of purchasable items is arranged to be purchased responsive to an interaction of a mobile device with said respective electronic display where the purchasable item is displayed thereon.

14. The method of claim 12, wherein said display updating of the second electronic display comprises a display of another of the plurality of purchasable items which is also displayed on the first electronic display.

15. The method of claim 14, wherein said displaying of the another purchasable item comprises replacing said displayed purchasable item with the another purchasable item.

16. The method of claim 12, wherein said predetermined relationship comprises a predetermined similarity between said determined unique profile of the first electronic display and said determined unique profile of the second electronic display.

17. The method of claim 12, wherein said determined unique profile of each of the plurality of electronic displays comprises an attribute of the location of the respective electronic display, said predetermined relationship comprising a predetermined relationship between said location attribute of the first electronic display and said location attribute of the second electronic display.

18. The method of claim 12, wherein said determined unique profile of each of the plurality of electronic displays comprises an attribute of consumers who have purchased items from the respective electronic display, said predetermined relationship comprising a predetermined relationship between said consumer attribute of the first electronic display and said consumer attribute of the second electronic display.

19. The method of claim 18, wherein said consumer attribute is arranged to be adjusted responsive to changes in the types of consumers who purchase items from the respective electronic display.

20. The method of claim 12, wherein said determined unique profile of each of the plurality of electronic displays comprises a common attribute of items purchased from the respective electronic display, said predetermined relationship comprising a predetermined relationship between said common item attribute of the first electronic display and said common item attribute of the second electronic display.
